(19) United States
(12) Patent Application Publication
(10) Pub. No.: US 2017/0054890 A1
(43) Pub. Date: Feb. 23, 2017

(54) IDENTIFICATION OF FLICKER AND BANDING IN VIDEO

(71) Applicant: Sound Devices, LLC, Reedsburg, WI (US)

(72) Inventors: Adam J. Wilt, Reedsburg, WI (US); Art Adams, Reedsburg, WI (US)

(21) Appl. No.: 14/829,779

(22) Filed: Aug. 19, 2015

(51) Int. Cl. H04N 5/235; H04N 9/04; H04N 5/232

(52) U.S. Cl. CPC H04N 5/2357; H04N 5/23293; H04N 5/2351; H04N 5/2353; H04N 9/04

(57) ABSTRACT

An illustrative device has a user interface configured to receive a user input, a processor, and a display configured to display a temporal difference map. The processor is configured to receive a plurality of digital images comprising a first digital image and a second digital image. The processor is also configured to store a portion of the plurality of digital images in a buffer memory. The buffer memory is configured to buffer a number of digital images received between the first digital image and the second digital image. The processor is further configured to receive, from the user interface, the user input. The user input indicates the number of digital images received between the first digital image and the second digital image. The processor is also configured to combine the first digital image and the second digital image to create the temporal difference map.

### BACKGROUND

The following description is provided to assist the understanding of the reader. None of the information provided or references cited is admitted to be prior art. Some types of lighting can appear continuous to the human eye but can contain rapid fluctuations in brightness and/or color. Such fluctuations can be seen in a video as a result of some methods of capturing video. The fluctuations seen in the video can be distracting to viewers and can be an undesirable artifact.

### SUMMARY

An illustrative device has a user interface configured to receive a user input, a processor, and a display configured to display a temporal difference map. The processor is configured to receive a plurality of digital images comprising a first digital image and a second digital image. The processor is also configured to store a portion of the plurality of digital images in a buffer memory. The buffer memory is configured to buffer a number of digital images received between the first digital image and the second digital image. The processor is further configured to receive, from the user interface, the user input. The user input indicates the number of digital images received between the first digital image and the second digital image. The processor is also configured to combine the first digital image and the second digital image to create the temporal difference map.

An illustrative method includes receiving, by a processor, a plurality of digital images comprising a first digital image and a second digital image. The method also includes storing, by the processor, the plurality of digital images in a buffer memory. The buffer memory stores a number of digital images received between the first digital image and the second digital image. The method further includes receiving, by a user interface, a user input that indicates the number of digital images received between the first digital image and the second digital image, combining, by the processor, the first digital image and the second digital image to create a temporal difference map, and displaying, on a display, the temporal difference map.

An illustrative non-transitory computer-readable medium has computer-readable instructions stored thereon that, upon execution by a processor, cause a device to perform operations. The instructions include instructions to receive a plurality of digital images comprising a first digital image and a second digital image. The instructions also include instructions to store the plurality of digital images in a buffer memory. The buffer memory stores a number of digital images received between the first digital image and the second digital image. The instructions further include instructions to receive a user input that indicates the number of digital images received between the first digital image and the second digital image, instructions to combine the first digital image and the second digital image to create a temporal difference map, and instructions to display the temporal difference map on a display.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

Illustrative embodiments will hereafter be described with reference to the accompanying drawings.

FIGS. 1A and 1B are diagrams showing the variations in the electrical cycle of a lamp during consecutive images captured using a rolling shutter video camera, where the video camera frame rate spans one lamp electrical cycle in accordance with an illustrative embodiment.

FIGS. 2A-2D are diagrams showing the variations in the electrical cycle of a lamp during consecutive images captured using a rolling shutter video camera, where the video camera frame rate spans 1.25 lamp electrical cycles in accordance with an illustrative embodiment.

FIGS. 3A-3F are diagrams showing the variations in the electrical cycle of a lamp during consecutive images captured using a rolling shutter video camera, where the video camera frame rate spans 1.1 lamp electrical cycles in accordance with an illustrative embodiment.

FIG. 4 is a block diagram of system components configured to output an image that can emphasize flicker and/or banding in accordance with an illustrative embodiment.

FIG. 5 is a block diagram of a device that can emphasize flicker and/or banding in accordance with an illustrative embodiment.

FIG. 6 is a flow diagram illustrating a method of processing images in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Some lighting can consist of fluctuations over time of brightness and/or color. Such fluctuations can be rapid and imperceptible to the human eye. Artificial lighting can contain such fluctuations as a result of the methods used to produce light. For example, magnetically-ballasted fluorescent lamps can be powered using alternating currents, typically using a 50 Hertz (Hz) or 60 Hz frequency.

In another example, light from light emitting diodes (LEDs) can be affected by rapidly applying electrical cycles to the LEDs. The perceived brightness of an LED can be modified by quickly applying power and removing power to an LED. One method is to use pulse width modulation to control the perceived brightness of the LED. In such an example, the LED can strobe. As with the fluorescent lights discussed above, the strobing can be imperceptible to the human eye, but can be noticed using a video camera, as discussed in more detail below.

Typical North American alternating current (AC) line frequency is 60 Hz. If a fluorescent lamp (or any other light source) is powered by such AC power, the current passing through the lamp pulsates twice every 1/60 of a second. The high point of each pulse (whether positive or negative) corresponds to the highest amount of current passing through the lamp in either direction. The low point of each pulse corresponds to the point of the cycle that has (momentarily) no current passing through the line (as the current cycles from one direction to the other).

Further, altering the amount of current passing through the lamp (e.g., fluorescent lamps) also changes the color emitted by the lamp. For example, some fluorescent lamps can emit light that is greener during the low-power portion of the cycle, and can emit light that has comparatively more magenta color during the high-power portion of the cycle. This is caused by phosphors that emit a greenish color that have a slower phosphorescent decay than the other phosphors in the lamp and, accordingly, glow for a longer time after being excited at peak power.

Video cameras can include optical sensors distributed across a grid, with each optical sensor associated with a pixel of a digital image. Video cameras can also include a shutter that can block light from hitting the optical sensors after the light passes through a lens. Video camera shutters can be mechanical shield-like shutters that pass over the optical sensors (in other instances, an electronic shutter can be used). Accordingly, as the shutter passes over the optical sensors, various optical sensors are exposed to light at different times. That is, the shutter does not expose all of the optical sensors to light at the same time.

Many video cameras use a rolling shutter method, which captures pixels of an image at different times. That is, each still image captured by a video camera contains pixels captured at different times. Instead of capturing all pixels at the same time, the rolling shutter (which can be mechanical or electronic) captures pixels of an image by scanning across the optical sensor grid. Such scanning can be vertical or horizontal. In an example of a rolling shutter with a vertical travel, the rolling shutter can travel from the top of the optical sensor grid to the bottom of the optical sensor grid. In such an example, the “top” of the optical sensor grid corresponds to the top of the resulting digital image. When a digital image is captured, the rolling shutter allows light to be captured starting at the top and travels to the bottom over time. Accordingly, pixels of the resulting digital image at the top of the image will have been captured before pixels at the bottom of the image. Such a process can happen in a fraction of a second.

Digital video cameras can have different shutter speeds. Shutter speeds of a video camera can correspond to, for example, the time span for a digital image to be captured. In the example discussed above, the shutter speed can correspond to the time it takes for the rolling shutter to travel from the top of the image to the bottom of the image. Digital video cameras can also have different frame capture rates (or frame rates). Frame rates can correspond to the number of images captured in a time span, for example fifty frames per second (fps). Thus, the frame rate also corresponds to the amount of time between starting to capture an image and starting to capture the subsequent image.

In an example, a digital video camera with a shutter speed of 1/60 of a second can have a frame rate of sixty frames per second and can capture each digital image of a video in 1/60 of a second. Using a fluorescent light with AC power at 60 Hz, each digital image of the video will span one full electrical cycle of the AC power and capture the resulting fluctuations in brightness and/or color of the ambient light, as discussed above. For example, at the beginning of capturing the digital image, starting at the top, an electrical cycle of the fluorescent light can begin as the AC power transitions from one direction to the other (the instantaneous current is 0 Amps). Accordingly, the brightness of the lamp can begin to increase. Pixels captured at the top of the image will capture light conditions that are at the lowest power and the light can be the dimmest in its cycle and can contain the most green color. As the shutter moves down the optical sensor grid, the electrical cycle of the light becomes more intense before dimming. When the shutter has moved one quarter of the way down the optical sensor grid, the pixels capturing the image are capturing light conditions that are at the highest power. For example, the light can be the brightest and contain the most magenta. In some embodiments, the brightness and color cycles of the light emitted from the lamp can lag or be offset from the electrical cycle of the lamp. The lag can be the result of the response time of the phosphor or other material to emit light after being excited by electricity.

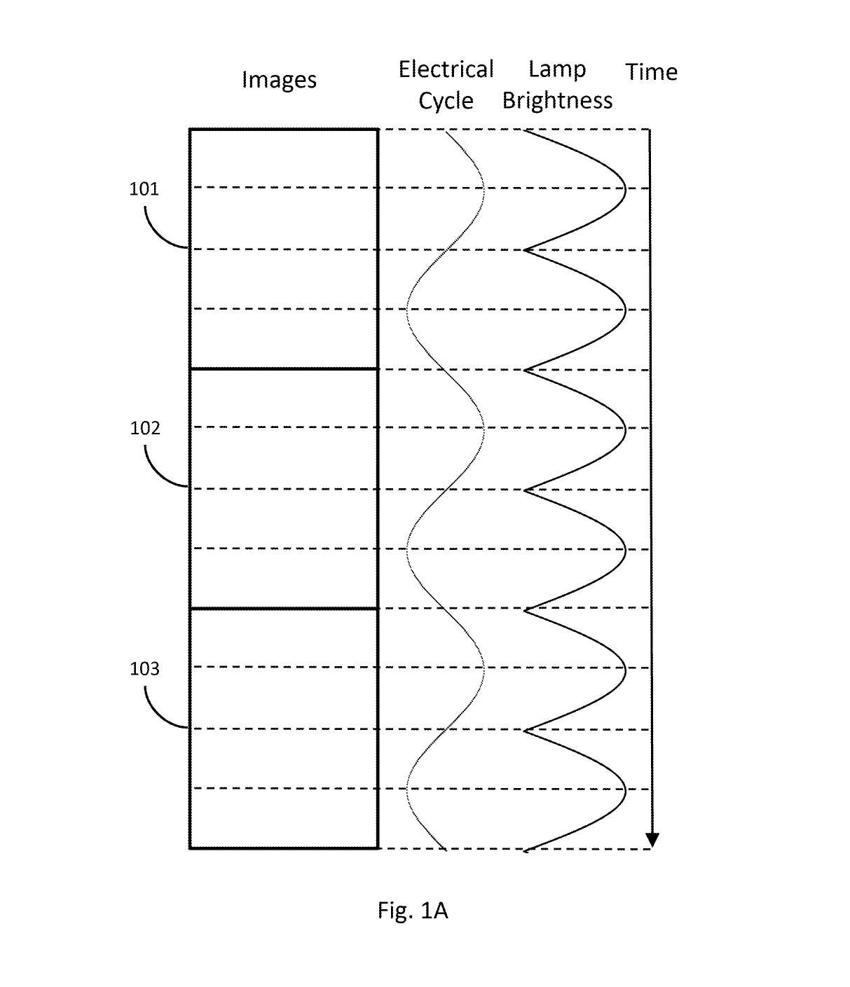

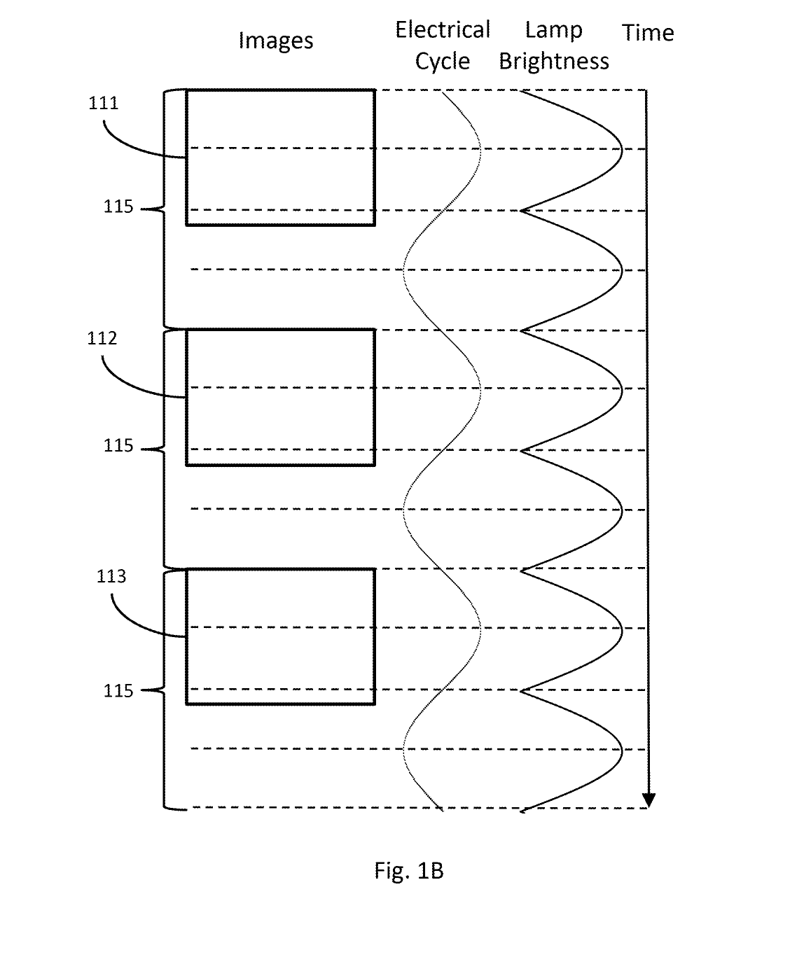

Continuing the cycle, halfway down the optical sensor grid, the pixels capturing the image are capturing light conditions again that are at their lowest power and are dimmest. The cycle repeats itself as the shutter travels across the bottom half of the optical sensor grid. Accordingly, the resulting image captures one full electrical cycle of the lights. Such an example is illustrated in FIG. 1A. FIGS. 1A and 1B are diagrams showing the variations in the electrical cycle of a lamp during consecutive images captured using a rolling shutter video camera, where the video camera frame rate spans one lamp electrical cycle in accordance with an illustrative embodiment. The video camera can capture consecutive digital images 101, 102, and 103. FIG. 1A also illustrates the electrical cycle of a lamp and the brightness of the lamp. As discussed in the example above, FIG. 1A illustrates a digital video camera with a rolling shutter moving from the top of the image to the bottom. In FIG. 1A, the time between the start of the capture of images is the same as the time it takes for the light power to make one full cycle.

In some instances, the direction of power (or electrical current), as discussed above, can be largely irrelevant to the brightness and color change of the light. The magnitude of the power determines the brightness and color of the light emitted by the lamp. That is, peak power, whether induced by positive or negative current, can produce the brightest light. The dashed lines of FIG. 1A correspond to the light produced by a lamp in its brightest and dimmest points. FIG. 1A also shows the brightness cycle of the lamp, corresponding to the peak power. In some instances, one of the two brightness pulses per cycle can be brighter than the other. That is, the pulses of one direction can be brighter than the pulses of the other direction.

As shown in FIG. 1A, a resulting image 101 can be brighter and more magenta colored in some horizontal areas than other areas, which can be dimmer and greener. The cycle can repeat itself with the capture of the following images 102 and 103. As shown in FIG. 1A, all images of a video can have the same pattern of brightness and color distributed vertically across the images. That is, as the video is played, all images will have the brightest pixels at ¼ and ¾ of the way down the image and have the dimmest pixels at the top, middle, and bottom of the image.

In the example illustrated in FIG. 1A, the shutter speed corresponds to the frame rate. That is, the time between the start of images being captured is the same as the time for the shutter to move down the optical sensor grid. As illustrated in FIG. 1B, in some embodiments, the shutter speed can be different than the time between images beginning to be captured. In the example illustrated in FIG. 1B, the shutter speed is less than the time between images beginning to be captured. In alternative embodiments, the shutter speed can be greater than the time between images beginning to be captured.

In FIG. 1B, timespan 115 can correspond to the frame rate. For example, if the frame rate is 24 frames per second (fps), then timespan 115 can be 1/24 seconds. Image 111, image 112, and image 113 can be captured with a shutter speed that is less than timespan 115. Similar to the example of FIG. 1A, image 111, image 112, and image 113 can be captured during the same portion of the lamp brightness cycle. That is, image 111, image 112, and image 113 have the same pattern of brightness and color distributed vertically across the images. Because the frame rate is in synch with the lamp brightness cycle, any shutter speed can be used to capture images with the same pattern of brightness and color distributed vertically across the images. As shown in FIG. 1B, by adjusting the shutter speed (e.g., as compared to FIG. 1A), the distribution of bright and dark bands can change. For example, image 101 of FIG. 1A can capture two bright bands and two dark bands. Image 111 of FIG. 1B, captured with a faster shutter speed than image 101, can capture about one bright band and one dark band. Thus, the number of bright and dark bands captured across each image can be adjusted by adjusting the shutter speed.

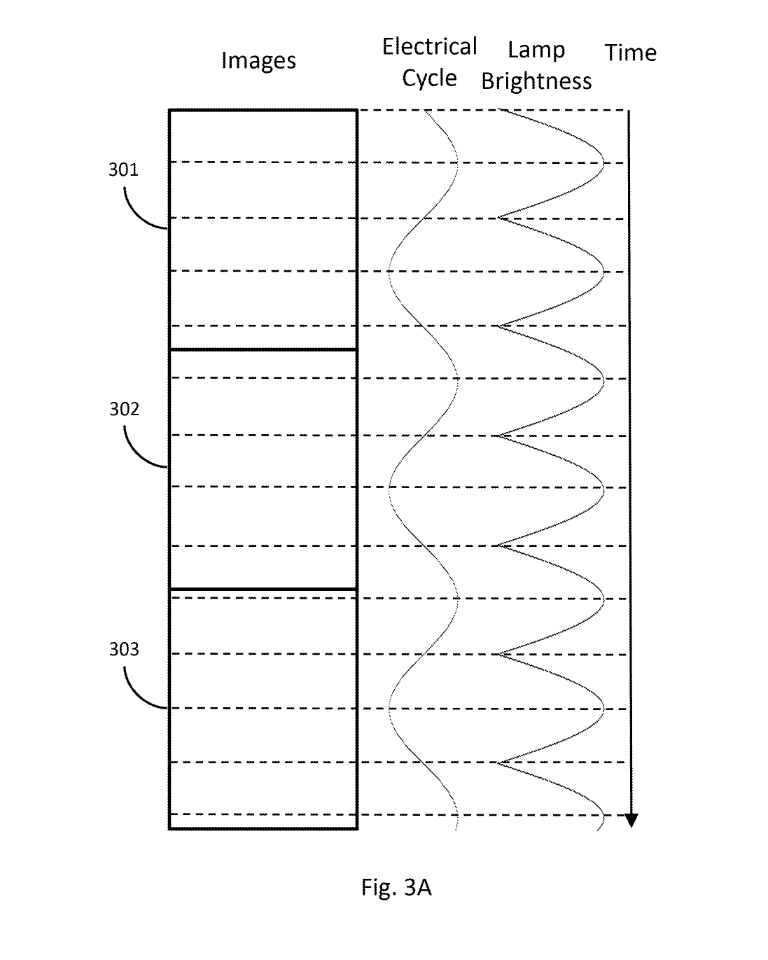

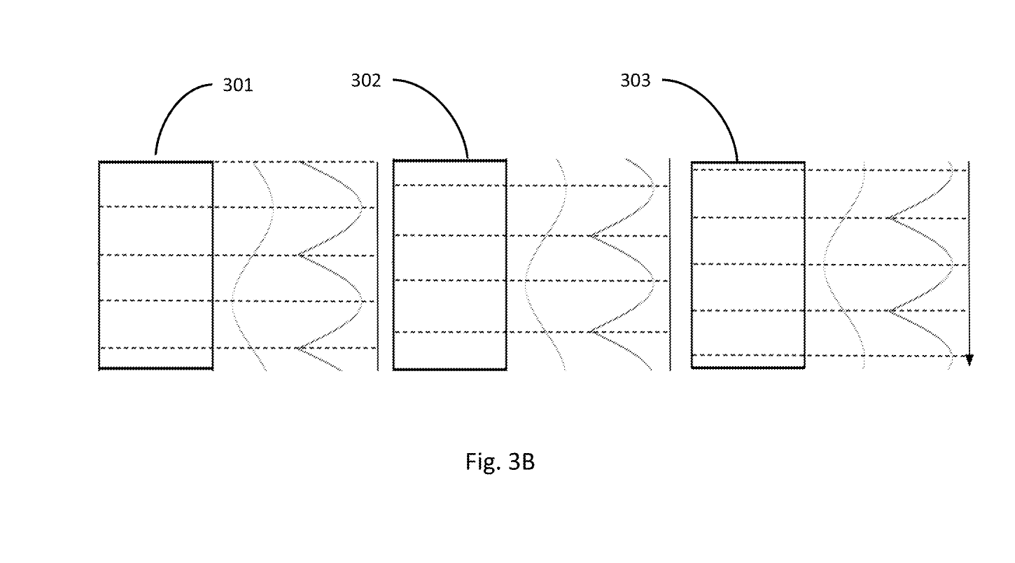

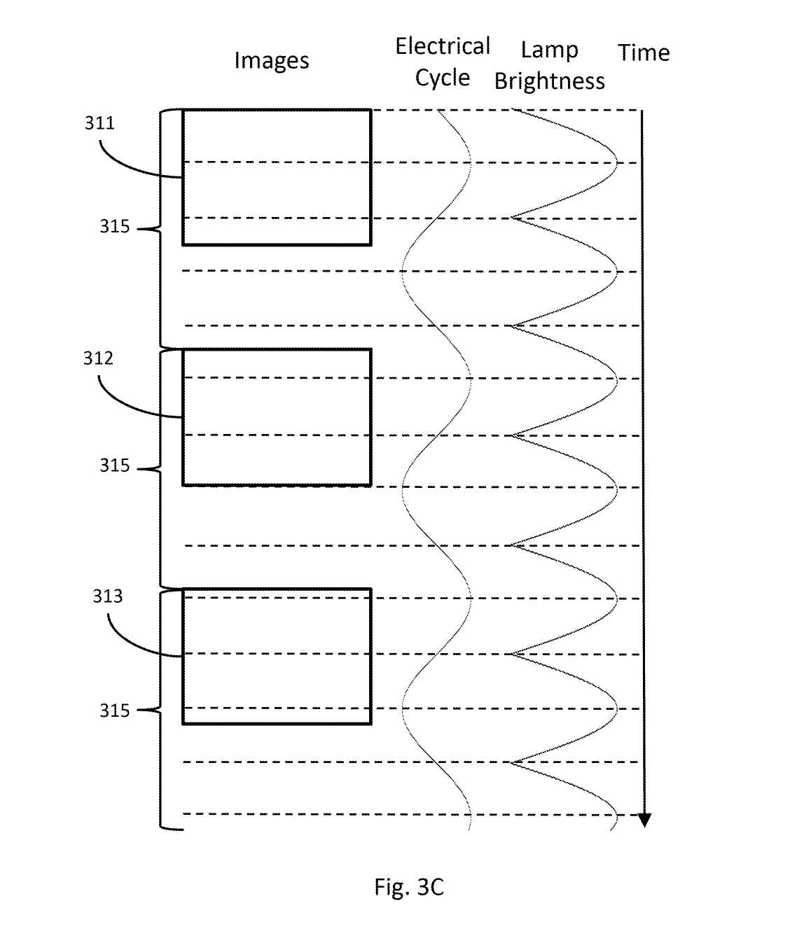

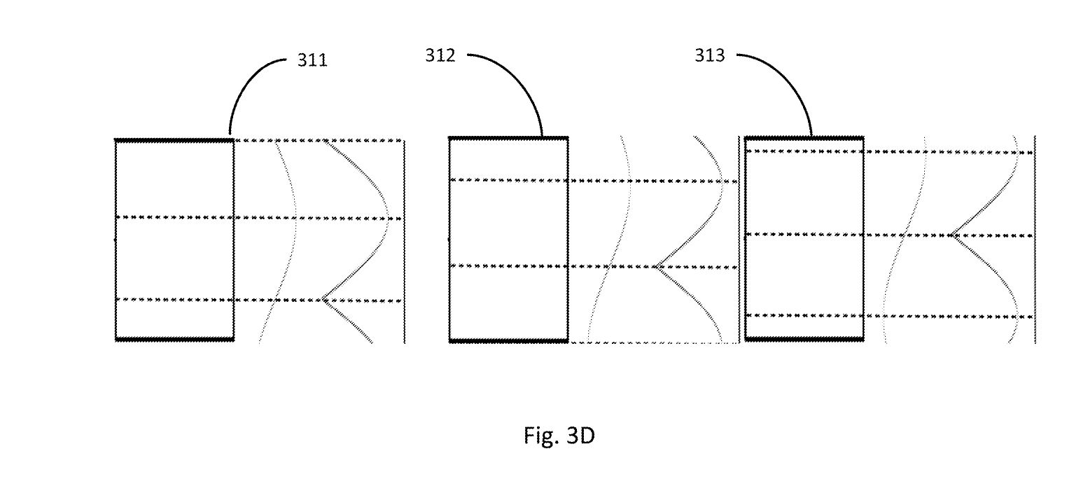

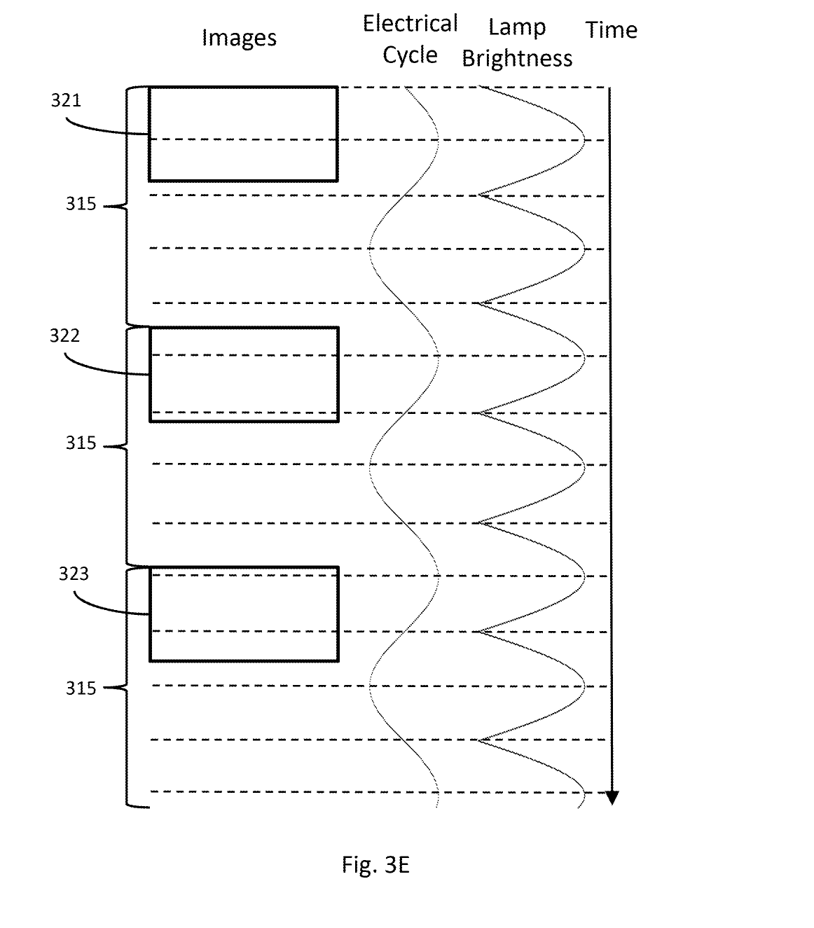

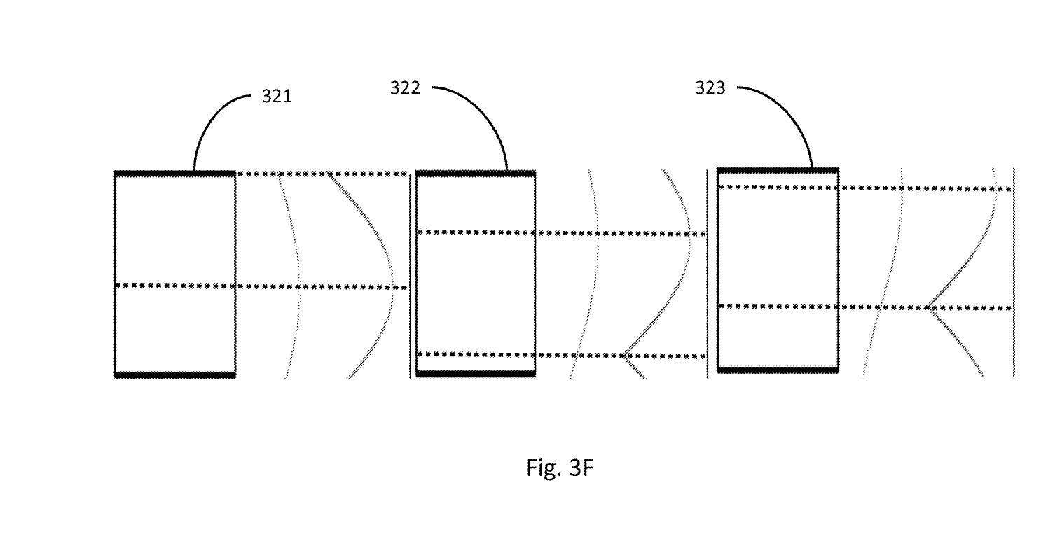

The thickness of the bright and dark bands in an image can also be altered by adjusting the shutter speed. FIGS. 1A and 1B show the lamp brightness over time as images are captured. Image 101 captures two brightness peaks of the lamp across the image 101, while image 111 captures one brightness peak across the image 111. Thus, the rate of change between bright and dark across an image can be adjusted by adjusting the shutter speed. As explained in greater detail below, the slopes of the brightness of image 301 and image 321 of FIGS. 3B and 3F, respectively, illustrate an example of lessening the rate of change between bright bands and dark bands across an image by using a faster shutter speed.

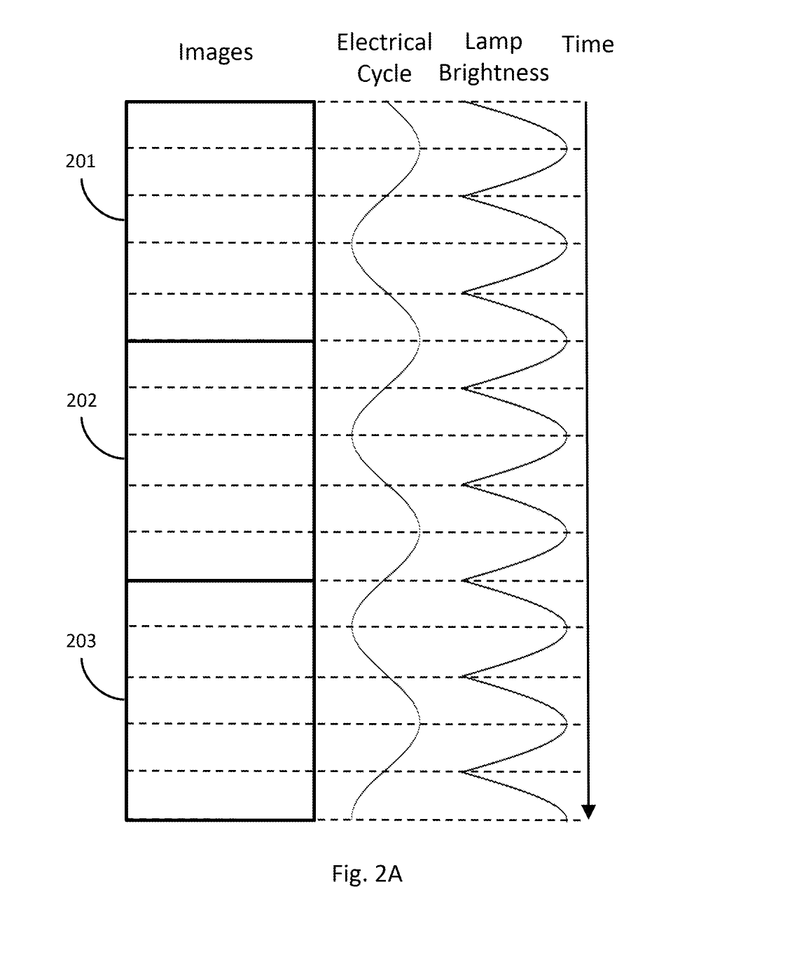

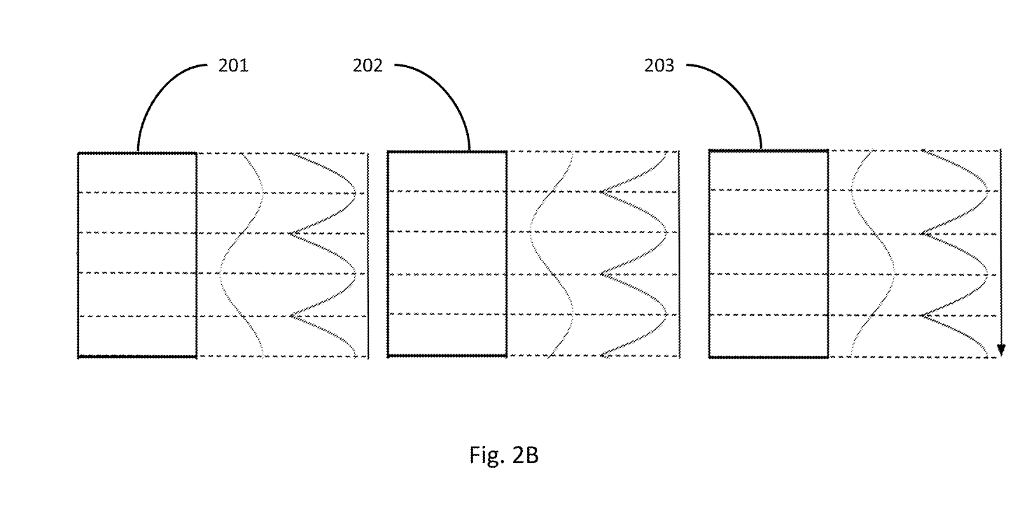

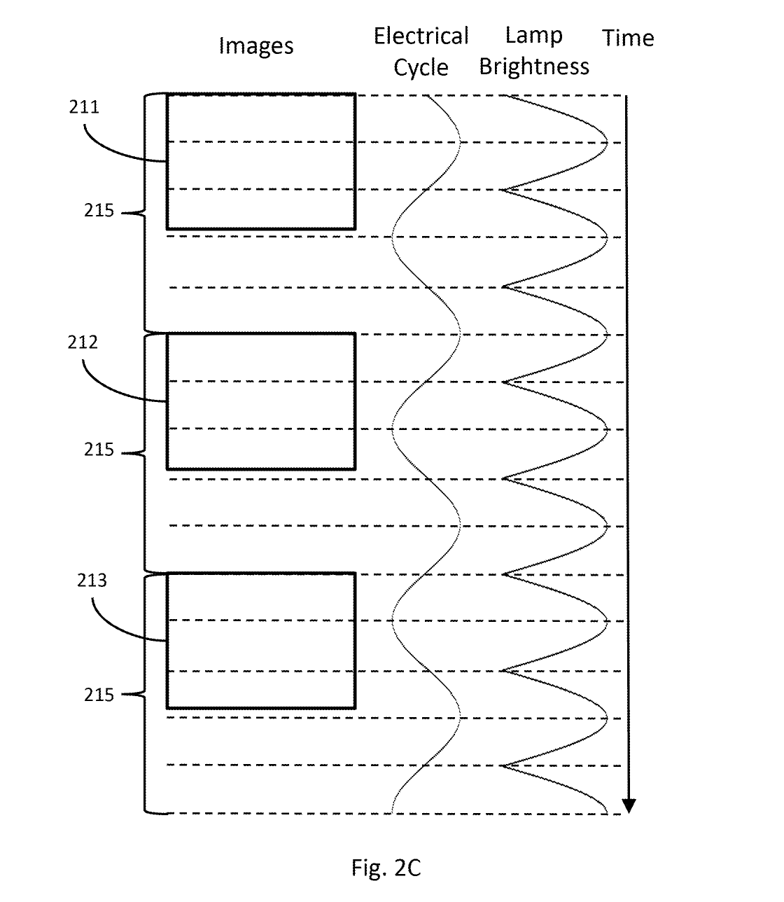

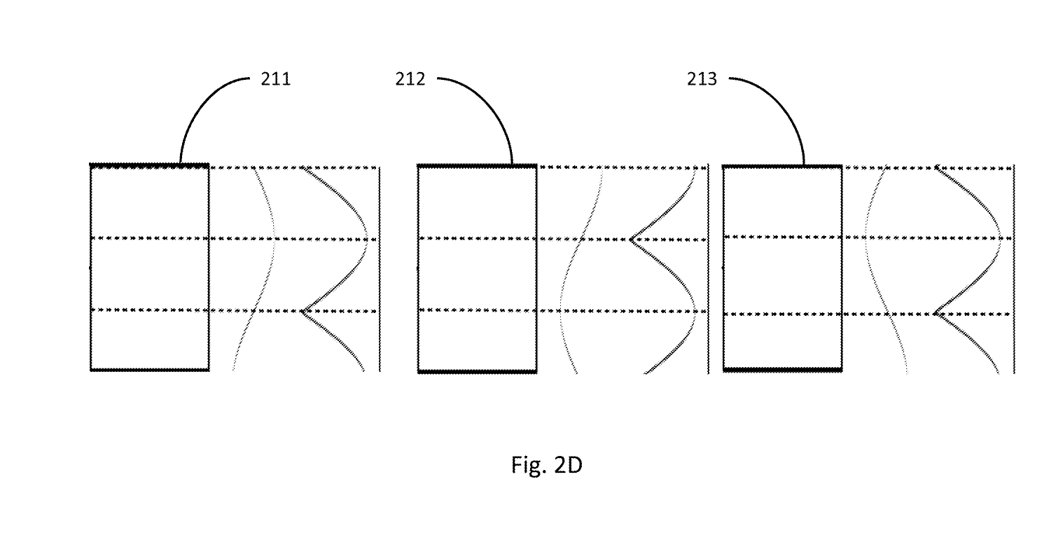

However, as discussed above, not all lighting is operated at 60 Hz. Furthermore, not all frame rates are 60 fps and/or correspond to the frequency of the lighting. Indeed, some common frame rates include 24 fps, 23.98 fps, 25 fps, 29.97 fps, 50 fps, and 59.94 fps. For example, for images captured with a frame rate of 48 fps, 1.25 electrical cycles of a 60 Hz lamp are completed from the time an image is beginning to be captured to the time the subsequent image is beginning to be captured. FIGS. 2A-2D are diagrams showing the variations in the electrical cycle of a lamp during consecutive images captured using a rolling shutter video camera, where the video camera frame rate spans 1.25 lamp electrical cycles in accordance with an illustrative embodiment. Similar to FIG. 1A, FIG. 2A illustrates the capture of consecutive images 201, 202, and 203 over time as the electrical cycle and, thus, brightness of a lamp changes. FIG. 2B shows the capture of images 201, 202, and 203 as in FIG. 2A, except that the images are presented horizontally to one another. Similarly, FIGS. 2C and 2D show the capture of images 211, 212, and 213, with FIG. 2D presenting the images horizontally to one another. The dashed lines of FIGS. 2A-2f correspond to the light produced by a lamp at its brightest and dimmest points.

FIGS. 2A and 2B show an example in which the shutter speed corresponds to the frame rate. As shown in FIG. 2B, images can be captured with a frame rate in which 1.25 lamp electrical cycles pass between the start of the capture of consecutive images. The captured images can have horizontal areas that change from the brightest area to the dimmest area from image to image. For example, the top of image 201 is captured when light emitted from the lamp is at its dimmest. The top of image 202 is captured when light emitted from the lamp is at its brightest. The top of image 203 is captured when light emitted from the lamp is again at its dimmest. As more images are captured, the cycle can repeat itself. Accordingly, when the images are played in a video, back-to-back, some areas of the screen (most notably, the areas surrounding the dashed lines) will appear to quickly transition from bright to dim, and appear to flicker or pulsate. Such a phenomenon can aptly be called “flicker.”

Flicker can be visible in a video even if the brightest horizontal regions of an image (e.g., image 201) do not exactly overlap the dimmest horizontal regions in the next image (e.g., image 202). Flicker can be present if any portion of a video transitions from a relatively bright area to a relatively dim area in consecutive images. As in the examples illustrated in FIGS. 2A and 2B, a shutter speed that is the same as the time between the capture of images and is 1.25 times the cycle length of the lamp electrical cycle is used to demonstrate an ideal condition for flicker, and is illustrative only. There are many other ratios that can result in flicker.

As mentioned above, the frame rate does not necessarily correspond with the shutter speed. FIGS. 2C and 2D illustrate an example of capturing images 211, 212, and 213 with a frame rate with a timespan 215 and a shutter speed less than the timespan 215. As in FIGS. 2A and 2B explained above, the frame rate corresponds to timespan 215 covering 1.25 lamp electrical cycles. Thus, as shown in FIG. 2D, in some instances flicker can still occur even if the shutter speed is modified.

A related phenomenon to flicker is banding, which can manifest in video as roll bars or striping. FIGS. 3A-3F are diagrams showing the variations in the electrical cycle of a lamp during consecutive images captured using a rolling shutter video camera, where the video camera frame rate spans 1.1 lamp electrical cycles in accordance with an illustrative embodiment. FIGS. 3A and 3B show the same information as FIGS. 2A and 2B, respectively, except that there is a different ratio between the frame rate of the video camera and the electrical cycle length of the lamp. FIGS. 3A and 3B illustrates a shutter speed at 1.1 times the cycle of the lamp power, but banding can happen at many different ratios, and 1.1 is chosen solely for illustrative purposes.

As shown in FIG. 3B, in consecutive images 301, 302, and 303, the brightest and dimmest areas of a video can appear to migrate over time. For example, pixels one quarter of the way from the top of image 301 are captured when the brightness cycle of the lamp is at its brightest. Pixels slightly above one quarter of the way from the top of image 302 are captured when the brightness cycle of the lamp is at its brightest. Pixels slightly below the top of image 303 are captured when the brightness cycle of the lamp is at its brightest. Accordingly, when consecutive images 301, 302, and 303 are played back in a video, the brightest horizontal areas will appear to move up along the image as time progresses. Such horizontal areas can be referred to as “roll bars,” and the phenomenon can be called “banding.”

FIGS. 3C-3F illustrate images captured with the same frame rate to lamp electrical cycle ratio, but with differing shutter speeds. FIGS. 3C and 3D illustrate a shutter speed that is less than the timespan 315, which corresponds to the frame rate. The shutter speed to frame rate relationship (e.g., ratio) of FIGS. 3C and 3D are the same as in FIGS. 1B, 2C, and 2D. FIGS. 3E and 3F illustrate a shutter speed that is faster than the shutter speed illustrated in FIGS. 3C and 3D.

Thus, FIGS. 3B, 3D, and 3F each show images captured with the same frame rate and with the same lamp electrical cycle, but with different shutter speeds. As discussed above, FIG. 3B shows that the bright and dark bands across image 301, image 302, and image 303, as viewed in sequence, move across the image. As the shutter speed is modified, the rate at which the bright and dark bands move across the images changes, as illustrated in FIGS. 3D and 3F. Further, by shortening the shutter speed, fewer and/or less bright and dark bands are captured in each image. Accordingly, in some instances, flicker and/or banding can be modified by modifying the shutter speed. For example, the banding shown in FIGS. 3A and 3B can be changed by changing the shutter speed. The bright and dark bands of image 301, image 302, and image 303 move across the images relatively slowly when compared to the movement rate of the bright and dark bands of image 311, image 312, and image 313 and the movement rate of the bright and dark bands of image 321, image 322, and image 323.

In some embodiments, the shutter speed can be increased such that only a portion of a lamp's brightness cycle is captured in each image. For example, only a small portion (e.g., 15%) of a lamp's brightness cycle can be captured in each image. In such embodiments, a resulting image may not have the bright and dark bands as illustrated in FIGS. 1A, 1B, 2A-2D, and 3A-3F. Rather such an image may vary in brightness and/or color across the image. In such embodiments, the brightness variation across captured images can be reduced, but the brightness variation between different images can be increased. For example, an image can be captured when a lamp is at its brightest, but the next image may be captured when the lamp is at its dimmest.

In some situations, flicker and banding can both occur. For example, if a frame rate spans slightly more or slightly less than 1.25 lamp electrical cycles (similar to FIGS. 2A-2D, which illustrate a frame rate that spans 1.25 lamp electrical cycles), flicker areas can appear to migrate across a video.

Flicker and banding are generally undesirable artifacts. When a video with flicker and/or banding is shown on a full-sized screen, the flicker and/or banding can be distracting to viewers. Even if the flicker or banding is subtle, the flicker or banding can be annoying or can reduce the quality of the video.

Flicker and banding can be problematic when special effects are added to a video or during editing of a video, such as compositing or keying. Compositing can be used to combine multiple image elements, which were shot separately, into a final image. Keying can be used to composite images together to fill holes in the images created by using image masks. In some instances, flicker and banding can cause inconsistencies in the brightness and/or color of an image within and/or between frames. When pulling a key (e.g., using image information to define a mask or matte used to composite two images), a key color of a specific hue and intensity can be selected (e.g. by using a green screen, blue screen, etc.). If the hue and brightness of the key color flicker or band, the matte will vary just as the flicker or banding of the scene varies, thereby making a chroma-key matte extraction difficult and, in some instances, so difficult as to be practically impossible. In such instances, each frame of a video can be corrected manually, which can be very time consuming and cost-prohibitive. In other instances, it can be possible but difficult to insert special effects (or remove portions of a scene) when flicker or banding are present in the original video because such special effects should match the flicker and banding of the original video if the special effects are to be integrated seamlessly (and unnoticeably). Indeed, when splicing two videos together, the different flicker or banding of the videos can make difficult the splicing of the videos such that a viewer does not notice the different individual videos. While the flicker or banding of any individual video may not be noticeable, when combined, the difference in flicker or banding can be noticeable.

Often, flicker and banding are not noticed until after the video has been captured, and editors are editing the video. Camera operators can attempt to minimize or eliminate flicker and/or banding. In some instances, camera operators can adjust frame rate and/or shutter speed to minimize flicker or roll bars. Another method that can be used to minimize flicker and banding can include changing the lighting conditions of the area being filmed.

However, camera operators can have a difficult time identifying flicker and/or banding at the time (or before) the video is captured. For example, if a camera operator uses an optical sight to identify the scene that the video camera is recording, the camera operator has no indication of flicker or banding because the camera operator is not viewing the individual images recorded by the camera. Some video cameras include a display such as a liquid crystal display (LCD) that is configured to display a sample of what the video camera is recording. However, such displays can have a screen refresh rate that is much slower than the recording frame rate of the camera. Additionally, such screens can display samples of what is being recorded. For example, such screens can display every fifth image recorded. Further, such screens can have a resolution, brightness, contrast, or other characteristics that can make detection of flicker or banding difficult, if not impossible. Indeed, flicker and banding can be subtle, even when displayed in full resolution and displaying every frame. Accordingly, detection of flicker and banding can be difficult even using cameras that show what is being recorded on a full screen television or other viewer.

Further, many video cameras can capture log images that are flat, low-contrast images that can be optimized later (which can be in post-production) for color correction. Thus, the low-contrast images viewed by the camera operator while filming can make it difficult for the camera operator to identify flicker or banding. Further, color correction of the images in post-production (after the video has been captured) exacerbates flicker and banding.

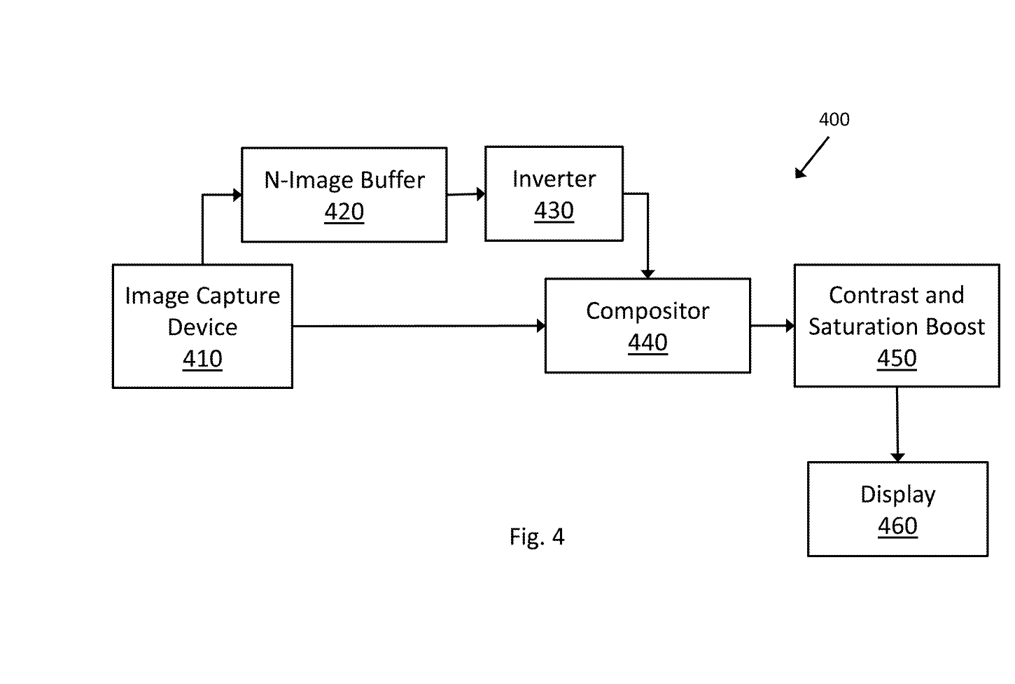

FIG. 4 is a block diagram of system components configured to output an image that can emphasize flicker and/or banding in accordance with an illustrative embodiment. In alternative embodiments, additional, fewer, or different elements may be used. Further, the order of blocks is illustrative only and not meant to be limiting. The block diagram of FIG. 4 is meant to conceptually illustrate illustrative embodiments. In some embodiments, one or more elements of FIG. 4 can be implemented via hardware, individual modules, and/or software. Also, in some embodiments, two or more elements of FIG. 4 can be combined (e.g., in a practical implementation of the elements). An illustrative system 400 can include an image capture device 410, an N-image buffer 420, an inverter 430, a compositor 440, a contrast and saturation booster 450, and a display 460.

The image capture device 410 can be any suitable image capture device. For example, image capture device 410 can be a video camera. The image capture device 410 can convert an image displayed on one or more optical sensors into a digital image and/or a digital video. Image capture device 410 can output a captured digital image (or a stream of captured digital images) to N-image buffer 420 (which can be a first-in-first-out buffer) and the compositor 440. In some embodiments, image capture device 410 is not used or included in system 400. For example, system 400 can be used with a plurality of images (e.g., a video) that is already recorded. In such embodiments, images can be received from a memory device that has the plurality of images stored therein. In some embodiments, images can be received from any suitable source. For example, images can be received from a play-back device configured to output images (which can be digital images) based on images stored on film. One example of a play-back device is a videocassette recorder (VCR). In some embodiments, a camera can be configured to capture images, store the images in film, and play-back the images stored in the film. Further, instead of a “recently captured” image being sent to the N-image buffer 420 and/or compositor 440, a next image in the sequence of images of the plurality of images can be sent to the N-image buffer 420 and/or compositor 440.

N-image buffer 420 can buffer received images in memory. N-image buffer 420 can buffer N number of frames, for example 1, 2, 3, 10, 100, 1000, etc. The number of images buffered by N-image buffer 420 can be dependent on the capture speed of the image capture device 410 and a delay. For example, a delay of 1 second can be desired. For an image capture device 410 that captures images at 24 frames per second, N-image buffer 420 can buffer 24 images. Any time delay can be selected, such as 0.01 seconds, 0.5 seconds, 0.9 seconds, 1 second, 1.5 seconds, 2 seconds, 10 seconds, etc. The time delay (or number of frames buffered) can be user selectable. N-image buffer 420 can be a first-in-first-out (FIFO) buffer.

An image output by N-image buffer 420 can be received by inverter 430. The image output by the N-image buffer 420 is a time-delayed image. That is, the image output by the N-image buffer 420 was captured N images before the most recent image output by image capture device 410. Inverter 430 can invert colors of the received image, thereby creating a negative of the image received. The image output by inverter 430, therefore, is a time-delayed negative image. The time-delayed negative image can be an input to compositor 440.

In alternative embodiments, inverter 430 can use any suitable method for producing inverted images. For example, input images can be monochrome or color images. In some instances, the color images can be represented in any suitable format, such as a YCrCb representation. In some embodiments, the pixels are represented in integer values (e.g., 0-255). In alternative embodiments, the pixels are represented using floating point values (e.g., 0.0-1.0). Any suitable method can be used to represent pixel values. In some embodiments, inverter 430 inverts the pixel values of the received image to create a negative of the image received by inverter 430. In some embodiments, inverter 430 inverts the brightness (and/or the color values) of the received image to create a negative of the received image.

For example, an image is an 8-bit image with brightness and color values that range from 0 to 255. Pixels with a value of 0 are inverted to have a value of 255 in the inverted image, and pixels with a value of 255 are inverted to have a value of 0. One illustrative method for inverting the values is to subtract the pixel value from 255 to determine the inverted pixel value. Thus, in some embodiments, all pixel values of the inverted image are positive values within the value range of the input image.

In alternative embodiments, negative pixel values can be used. For instance, the sign of pixel values of the input image can be reversed to determine the pixel values of the inverted image. For example, a pixel value of the received image with a value of 255 corresponds to a pixel value of the inverted image with a value of 255. In some embodiments, the maximum value (e.g., 255 in the examples above) can be added to the negative pixel value to obtain the inverted image pixel value.

In alternative methods, a lookup table can be used. Any suitable method can be used to invert images. The method can be chosen based on the hardware and/or to increase efficiency and/or speed.

Compositor 440 can receive a recently captured image from the image capture device 410 and the time-delayed negative image from inverter 430. In alternative embodiments, system 400 can include an additional buffer located between the image capture device 410 and compositor 440. In such embodiments, images received by compositor 440 from the image capture device 410 via the additional buffer can have been captured before or after the time-delayed negative image received by compositor 440 from inverter 430. In other embodiments, inverter 430 can be located between image capture device 410 and compositor 440. In yet other embodiments, inverter 430 can be located between image capture device 410 and N-image buffer 420. In such embodiments, compositor 440 can receive a negative image from image capture device 410 via inverter 430 and a time-delayed image from image capture device 410 via N-image buffer 420.

In system 400 illustrated in FIG. 4, compositor 440 can combine a time-delayed negative image received from inverter 430 and a recently captured image received from image capture device 410. Compositor 440 can combine such images by overlaying the time-delayed negative image and the recently captured image. The opacity of one of the images can be halved and overlaid on the other image, thereby combining the images. In other embodiments, other methods can be used such that a resulting combined image comprises pixels with a brightness derived half from one image and half from the other. In some embodiments, the time-delayed negative image can be combined with the recently captured image using an alpha-blending process with an opacity of 50%.

In embodiments in which negative pixel values are used, compositor 440 can output an image by subtracting the time-delayed image from the recently-captured image and adding a color offset. The color offset can be grey. For example, the color offset for a pixel value range of 0-255 can be 128. Thus, in an illustrative embodiment, the output pixel value equals the recently-captured pixel value minus the time-delayed pixel value plus half of the maximum pixel value. In such an embodiment, the inverter 430 may not be used. In some embodiments, the inverter 430 and the compositor 440 are combined into the same unit or step. Compositor 440 can combine such images using any suitable method. For example, values representing the color of each pixel in the time-delayed negative image can be added to values representing the color of each corresponding pixel in the recently captured image.

In some embodiments, the image capture device 410 can be configured to capture color images. In an illustrative embodiment, the various components of system 400 can be configured to process the color images. In some embodiments, the image capture device 410 can be configured to capture monochromatic images (e.g., black-and-white images, green-and-white images, sepia images, etc.). In other embodiments, image capture device 410 can be configured to capture color images, and system 400 can be configured to convert the color images into monochromatic images. In embodiments in which monochromatic images are used, the amount of storage used to store the images can be reduced when compared to the use of color images. Alternatively, more monochromatic images can be stored in a storage device than color images. Further, in some embodiments, the use of monochromatic images can increase the speed of processing the images when compared to using color images.

In an alternative embodiment, system 400 may not include an inverter 430. Accordingly, compositor 440 can receive a time-delayed image from N-image buffer 420 and a recently captured image from image capture device 410. In such an embodiment, compositor 440 can combine such images by subtracting color values of each pixel of the time-delayed from color values of each corresponding pixel of the recently captured image. In alternative embodiments, any suitable method can be used to achieve the same result.

In some alternative embodiments, compositor 440 combines an image received by N-image buffer 420 (or inverter 430) and a constant image. For example, a stream of images (e.g., video) can be received by image capture device 410 and sent to the N-image buffer 420. One of the images (e.g., the first image, the tenth image, an image selected by a user, etc.) can be used as a constant comparison. That is, the image can be combined with the image received by the N-image buffer 420 (or inverter 430) instead of a recently captured image from image capture device 410. The resultant combined image(s) can be used to identify effects that changes in settings have if the changes are made between the time the constant image was captured and the time the image received from the N-image buffer 420 (or inverter 430) was captured. In some embodiments, an N-image buffer 420 may not be used. Instead, a stream of images is sent to inverter 430 and combined with the constant image.

The combined image can be a temporal difference map. The temporal difference map can be an image that displays the differences between the time-delayed image output by the N-image buffer 420 and the recently captured image output by the image capture device 410. That is, if the image capture device 410 captures exactly the same image N+1 times, the image output by the N-image buffer 420 and the image capture device 410 will be identical. Accordingly, the temporal difference map output by the compositor 440 will be a solid, uniform grey image. The temporal difference map can have a grey, 50% brightness value in pixels in which the time-delayed image and the recently captured image are the same and can have pixels that vary from the grey, 50% brightness value where there are differences in the time-delayed image and the recently captured image.

Images illustrated in FIG. 1A can be used as an example. Images 101, 102, and 103 can be images of the same scene. N-image buffer 420 can be a 2-image buffer. In such an example, image 101 can be output from N-image buffer, inverted by inverter 430, and input into compositor 440. Image 103 can be the recently captured image and input into the compositor 440. The negative, time-delayed version of image 101 can be combined with image 103 by the compositor 440 to produce a temporal difference map. Because images 101 and 103 are of the same image and the relation of the shutter position and the lamp brightness cycle are identical, the temporal difference map will not show any differences. The temporal difference map will be solid, flat grey.

However, most image capture devices do not capture identical images over time, even when the scene captured has not changed. Some reasons include fluctuations in light and random (or non-random) noise. Accordingly, if the only difference between the image output by the N-image buffer 420 and the recently captured image output by the image capture device 410 is random noise, the temporal difference map will be a grey image with random deviations from grey at one or more pixels. However, the overall image will appear grey. In some instances, the image may appear “snowy.”

Significant, non-random differences between the image output by the N-image buffer 420 and the recently captured image output by the image capture device 410, however, can appear as color and/or brightness variations in the temporal difference map. The color variations can be variations in hue and/or saturation. Images illustrated in FIGS. 2A and 2B can be used as an example. As discussed above, image 201 can be output from the N-image buffer 420 and image 202 can be the recently captured image output by the image capture device 410. In such an example, N images can be captured between image 201 and image 202. The temporal difference map will show bands of color and/or brightness. The strongest variations in colors will be displayed along bands where the differences in the lamp's power brightness cycle (and, accordingly, difference in captured brightness and/or color) are the greatest. Grey bands will appear where the difference in the absolute value of the lamp's electrical cycle is the least. Differences in brightness can also appear as bands in the temporal difference map. Bands that are darker and/or bands that are lighter than the baseline (grey) image can appear. Accordingly, flicker can be detected in the temporal difference map by detecting bands of color and/or bands of differing brightness.

However, using the example above, if the number of buffered images in the N-image buffer 420 is increased by one, then the output of the N-image buffer 420 can be image 201 and the recently captured image input to the compositor 440 can be image 203. Because the lamp brightness cycle is identical in images 201 and 203, the temporal difference map will be solid grey, as in the example above using images 101 and 103. Thus, altering the number of images buffered by N-image buffer 420 can show or hide evidence of flicker in the temporal difference map.

The temporal difference map can also be used to detect banding. Images illustrated in FIGS. 3A and 3B can be used as an example. As above, image 301 can be output by N-image buffer 420 and image 302 can be the recently captured image input to the compositor 440 by the image capture device 410. As shown in FIG. 3, the difference in the lamp's brightness cycle is relatively small across the entire image. The difference is not as great as some of the differences of the brightness and/or color bands discussed above with regard to images 201 and 202 of FIGS. 2A and 2B. Accordingly, the brightness variations and the colors of the temporal difference map will not be as vibrant or bright using images 301 and 302 as the colors of the temporal difference map using images 201 and 202, discussed above. However, because the magnitude of differences between the lamp's brightness in images 301 and 302 are relatively small, the temporal difference map will show relatively little color along the entire temporal difference map. In such a temporal difference map, the color displayed in the temporal difference map may not be the same (e.g., some parts may be more magenta and some parts may be more green), but there can be color throughout the temporal difference map. The temporal difference map using images 301 and 302 above may show slight color across the entire temporal difference map, but because the color is slight, it may be difficult to notice the color. Similarly, because the differences in the brightness of the lamp in images 301 and 302 are relatively small, the temporal difference map can have relatively little variations in brightness. That is, differences from the baseline (grey) image brightness may be small. Accordingly, in some instances, the temporal difference map may be deceptively grey in color and, as a result, flicker or banding occurring in the video may not be as readily apparent.

However, if the number of images buffered by N-image buffer 420 is increased by one, the resulting temporal difference map may more readily identify the banding (or flicker). In such an example, image 301 can be output by N-image buffer 420 and image 303 can be the recently captured image input to the compositor 440. As shown in FIGS. 3A and 3B, when the light brightness cycle of image 301 is at its brightest, the light brightness cycle of image 303 is near its dimmest. While the lamp brightness cycle of images 201 and 202 are exactly 180 degrees apart, the lamp brightness cycle of images 301 and 303 are nearly 180 degrees apart. Accordingly, the temporal difference map using images 301 and 303 may be similar to the temporal difference map discussed above with regard to images 201 and 202. That is, the temporal difference map can have bands of strong colors and/or variations in brightness. However, because the differences in the portion of the lamp brightness cycle (as captured by the image capture device) between images 301 and 303 are not as great as the differences in the portion of the lamp brightness cycle between images 201 and 202 (compare FIG. 3B and FIG. 2B), the color bands and/or variations in brightness of the temporal difference map of images 301 and 303 will not be as strong as the color bands and/or variations in brightness of the temporal difference map of images 201 and 202. Similarly, because there is a difference between the lamp brightness across almost all of images 301 and 303, almost all of the temporal difference map will have some color, similar to the example discussed in the above paragraph with regard to images 301 and 302. Additionally, there may be variations in the brightness of the temporal difference map because of the differences in lamp brightness across images 301 and 303. Accordingly, by adjusting the number of images buffered by N-image buffer 420, banding (and flicker) shown in the temporal difference map can be emphasized.

Accordingly, adjusting the time delay (e.g., the number of images buffered in N-image buffer 420) can help identify flicker and/or banding. For example, a camera with a capture rate of 24 fps capturing video under lamps using 60 Hz power is subject to a 12 Hz flicker rate. If the video is delayed by an even number of frames (e.g., N=2, 4, 6, etc.), the images combined by the compositor 440 will be in the same phase of the flicker cycle and, therefore, the temporal difference map may not show any flicker. Conversely, if the video is delayed by an odd number of frames (e.g., N=1, 3, 5, 7, etc.), the images combined by the compositor 440 will be in opposite phases of the flicker cycle and, therefore, the temporal difference map may clearly show color and/or variations in brightness, evincing flicker.

Further, if the video is delayed by a relatively small number of images, then banding will not have had enough time to develop (e.g., move across the screen) and it may be difficult to identify the banding in the temporal difference map. Accordingly, in some circumstances, a time delay of one to two seconds can be used to identify banding (e.g., flickering or non-flickering banding). For example, if the camera is capturing images at a rate of 29.97 fps or 59.94 fps under a lamp powered with 60 Hz power, a time delay of one to two seconds can be used. Such a time delay can provide sufficient difference in the power phase cycle of the lamp between the images combined by the compositor 440 to enhance identification of banding in the temporal difference map. Similarly, if the banding moves across the screen fast enough (during normal replay speeds) or if the time delay is equal to (or about) the time it takes a roll bar to move across the screen, then banding may not be easily identifiable in the temporal difference map.

Thus, modifying the time delay can help to identify flicker and/or banding. Additionally, in some embodiments, such as when the video camera is capturing images at a non-typical rate (e.g., filming at higher or lower frame rates than the playback rate to capture scenes with either a slow-motion or a fast-motion temporal effect) or when the power frequency of the lighting is unknown, the type and timing of flicker and/or banding can be unknown. Accordingly, allowing a variable time delay can be helpful in identifying flicker and/or banding.

As noted above, the temporal difference map can display the differences between the time-delayed image output by the N-image buffer 420 and the recently captured image output by the image capture device 410. Because flicker and banding are differences in the brightness and/or color of images, the temporal difference map can be used to identify flicker and banding. However, another source of differences between the time-delayed image output by the N-image buffer 420 and the recently captured image output by the image capture device 410 can be the result of a change in a scene that the camera is capturing. Accordingly, the image capture device 410 can be configured to capture multiple images of the same scene. For example, the image capture device 410 can be secured or fastened in a stationary position and aimed at a stationary scene. If the scene is changed or something in the scene moves between the time-delayed image output by the N-image buffer 420 is captured and the recently captured image is captured, the temporal difference map will show differences in the images that include flicker, banding, and differences caused by the movement.

In some instances, the differences caused by the change in scene or movement in the scene can be greater than differences caused by flicker and/or banding. Accordingly, in some instances, it can be difficult to identify flicker and/or banding from the temporal difference map if the camera is moving or there is movement in the scene. However, in some instances, differences caused by movement in the scene or movement of the camera can be shown in the temporal difference map, but not be so great as to overwhelm differences caused by flicker and/or banding. For example, in some instances, flicker and/or banding can be seen in a temporal difference map even if the camera is tapped, or knocked. In another example, flicker and/or banding can be seen in a temporal difference map if movement in a scene is isolated in a portion of the captured images.

Compositor 440 can output the temporal difference map. In some embodiments, the temporal difference map can be sent to display 460 without any adjustment to characteristics of the temporal difference map. In the embodiment shown in FIG. 4, the temporal difference map is received by a contrast and saturation booster 450. Contrast and saturation booster 450 can modify characteristics of the temporal difference map. Contrast and saturation booster 450 can increase the contrast and/or saturation of the temporal difference map to predetermined levels. In some embodiments, contrast and saturation booster 450 can increase the contrast and/or saturation of the temporal difference map to levels selectable by a user. In some embodiments, contrast and/or saturation can be increased by 5 times (5×) to 50 times (50×). In other embodiments, contrast and/or saturation can be increased by any suitable amount, such as 1.5×, 2×, 3×, 75×, 100×, etc. The increase to contrast and/or saturation can be an increase based on the unity value of the pixels. For example, a temporal difference map can be a grey image with 50% brightness with variations of +/−2%. A contrast boost can increase the variations. Thus, in such an example, a contrast boost of 20× increases the variations from the 50% brightness from +/−2% to +/−40%. In such an example, the dimmest pixel's brightness is 10% and the brightest pixel's brightness is 90%. In alternative embodiments, system 400 can include only a contrast booster or only a saturation booster. In other embodiments, the contrast and saturation booster can modify other aspects of the temporal difference map, such as brightness, hue, gamma, etc. Contrast and saturation booster 450 can modify aspects of the temporal difference map such that differences in the time-delayed image output by the N-image buffer 420 and the image capture device 410 are emphasized.

The boosted (or un-boosted) temporal difference map can be displayed on display 460. Display 460 can be any display known to those of skill in the art. For example, display 460 can be a cathode-ray tube (CRT), a liquid crystal display (LCD), a plasma display, an organic light-emitting diode (OLED) display, etc. Display 460 can be, for example, display 520, discussed in greater detail below.

In some embodiments, the method discussed above with regard to FIG. 4 can be run continuously. The process can be run for each new image captured by image capture device 410. In some embodiments, the process can be run for every second new image captured, every third new image captured, every tenth new image captured, etc. by image capture device 410. In such embodiments, the display 460 can be configured to display the consecutive temporal difference maps.

The temporal difference maps can be used by a camera operator (or a video engineer, a digital imaging technician, etc.), for example. The camera operator can make adjustments in an attempt to minimize flicker and/or banding. For example, the frame rate and/or shutter speed of the image capture device 410 can be adjusted. By adjusting the frame rate, the amount of time between the start of an image being captured is adjusted. Thus, the number (or fraction) of a lamp's brightness cycle between the start of images being captured can change. Adjusting the frame rate can vary the phase difference of the lighting cycle in succeeding frames.

By adjusting the shutter speed of the image capture device 410, the portion of the lamp's brightness cycle can be varied. For example, by increasing the shutter speed (e.g., capturing images in less time), less of the lamp's brightness cycle (or fewer brightness cycles, etc.) is captured in each frame. Similarly, by decreasing the shutter speed (e.g., capturing images over more time), more of the lamp's brightness cycle (or more brightness cycles, etc.) is captured in each frame. Thus, the frame rate and/or shutter speed can be adjusted by the camera operator to affect flicker and/or banding, which, as explained above, are the result of capturing images during portions of the lamp's brightness cycle.

Similarly, adjustment of the shutter speed of the image capture device 410 can affect flicker and/or banding. Adjusting the shutter speed, which is the amount of time it takes for the camera to capture an image, also changes the portion of the lamp's brightness cycle captured in each image. Thus, shutter speed can be adjusted to change (e.g., minimize) the amount of flicker and/or banding.

The temporal difference map can also be used to modify variables that are not settings of the image capture device 410. For example, adjusting the angle of lamps, the number of lamps, etc. of a scene can affect the light sensed by the image capture device 410. FIGS. 1A, 2A, and 3A, explained above, are examples of a camera capturing light from a single lamp or from multiple lamps that reach the camera at the same phase during the brightness cycle of the lamps. In some embodiments, if multiple lamps are used (e.g., lamps using different brightness phases), the various light beams from the multiple lamps sensed by the camera can be out of phase from one another. In some instances, the multiple lamps can be out of phase in such a way that flicker and banding are reduced. That is, the differences in light during the different points in the phase can, from the viewpoint of the camera, average together such that a more consistent light is sensed by the camera. In such instances, there can be less fluctuation in brightness, color, etc.

As discussed above, more color and/or variations in brightness in the temporal difference maps can indicate more flicker and/or banding. Accordingly, the camera operator can adjust one or more settings, conditions, etc. to reduce the amount of color and/or variations in brightness on the temporal difference map. That is, the camera operator can make adjustments to minimize the amount of color and/or variations in brightness displayed on the most recent temporal difference map. After an adjustment is made, the camera operator can observe the affect the adjustment has on the temporal difference map.

In some embodiments, a temporal difference map of a portion of images can be displayed. For example, a temporal difference map can be displayed for a zoomed-in portion of a video. In some embodiments, image capture device 410 is configured to output to the N-image buffer 420 and the compositor 440 a portion of images. The portion of the images can be the same portion for each of the images. For example, a 200 pixel×200 pixel portion of the images can be output by the image capture device 410 and the location of the 200 pixel×200 pixel portion can be the same in each image (e.g., the top left 200 pixel×200 pixel portion). Thus, in such an embodiment, system 400 can be used on the portion of images output by the image capture device 410. In some embodiments, the system 400 can be run using full-sized images and display 460 can be configured to display only a portion of the temporal difference map.

In some embodiments, the number of frames buffered by the N-image buffer 420 (e.g., the number of frames between the frames input into the compositor 440) can vary. In some embodiments, the number of frames can vary automatically. That is, in some embodiments, system 400 can use an automated time delay. For instance, the time delay between the images used to create the temporal difference map can vary (or scroll) to display different temporal difference maps with different time delays, thereby displaying various instances of flicker and banding. For example, a first temporal difference map can use a time delay of one second. The system 400 can use the one-second time delay for a single frame or for multiple frames. For example, the one-second time delay can be used for half of a second. The one-second time delay can be used for any suitable amount of time, such as one second, 1.1 seconds, 1.5 seconds, two seconds, etc. The time delay used by the system 400 can then be changed. The next time delay can be any suitable time delay. For example, the next time delay can be one frame less than one second. For example, if the frame capture rate is 24 fps, 23 frames can be between the images used to create the temporal difference map. That time delay can be used for any suitable amount of time (e.g., half of a second). The following time delays can continue to decrement by one frame (or any other suitable number of frames or amount of time). In alternative embodiments the consecutive time delays can increment.

In some embodiments, a predetermined number of time delays can be used. Using the example above, each time delay can be used for half of a second. The time delays used can be one second, one frame less than one second, two frames less than one second, and three frames less than one second. The system 400 can cycle through the various time delays and repeat the sequence.

In some embodiments, each cycle of time delays can include multiple base time delays. In the example above, the base time delay is one second, with the consecutive time delays a certain number of frames different than one second. For example, the time delays used can be one second, one frame less than one second, two frames less than one second, three frames less than one second, four frames (e.g., the amount of time it takes to capture four frames), three frames, two frames, and one frame. In alternative embodiments, any suitable base time delays can be used (e.g., a tenth of a second, a half second, one second, two seconds, etc.), and any suitable number of base time delays can be used. Also, in alternative embodiments, any suitable change from the base time delays can be used. Although the examples above use a difference of one frame between consecutive time delays, any suitable difference between consecutive time delays can be used (e.g., two frames, ten frames, a tenth of a second, one one hundredth of a second, two one hundredths of a second, etc.).

The automated time delay can be initiated in response to receiving a user input indicating that the automated time delay should be used. In some embodiments, user inputs can be used to determine the number of base time delays to be used in the automated time delay, the variations from the base time delays, the amount of time each time delay is used, etc. In some embodiments, the automated time delay can be used without user input (e.g., the various settings can be predetermined). The use of the automated time delay can provide a user with a convenient method of scrolling through various time delays that can be used to display the presence of banding and flicker.

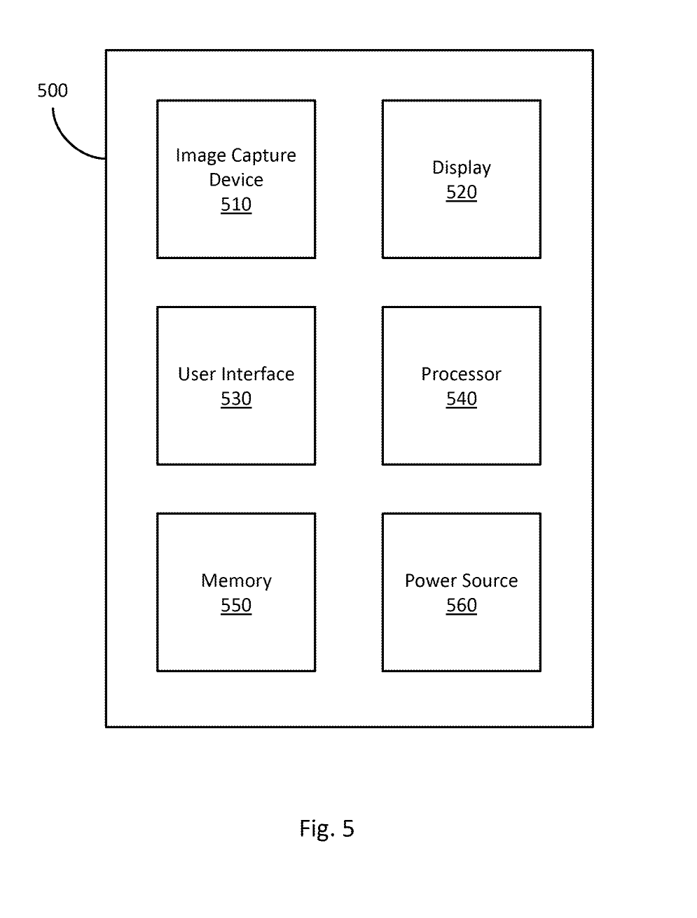

FIG. 5 is a block diagram of a device that can emphasize flicker and/or banding in accordance with an illustrative embodiment. In alternative embodiments, additional, fewer, or different elements may be used. Flicker identification device 500 can include image capture device 510, display 520, user interface 530, processor 540, memory 550, and power source 560. In some embodiments, the various elements of flicker identification device 500 can be included in a single device. In other embodiments, some or all of the various elements of flicker identification device 500 can be included in multiple devices. For example, in some embodiments, image capture device 510 can be a stand-alone video camera, and the various other elements can be in a separate, stand-alone device. Although flicker identification device 500 is referred to herein as a “flicker” identification device, it should be understood that the device can be used to identify banding in addition to or instead of flicker.

Image capture device 510 can be any image capture device known in the art. Image capture device 510 can capture images, such as video. The images and/or video can be analog or digital. In embodiments in which image capture device 510 captures analog images and/or video, flicker identification device 500 can be configured to convert the analog images and/or video into digital images and/or video.

Flicker identification device 500 can also include display 520. Display 520 can provide an interface for presenting information from flicker identification device 500 to external systems, users, or memory. For example, display 520 may include an interface to a display or other device configured to indicate the presence of flicker and/or banding in a video. Display 520 may also include alarm/indicator lights, a network interface, a disk drive, a computer memory device, etc.

Display 520 can be configured to display one or more temporal difference maps. For example, display 520 can be configured to display a continuous stream of temporal difference maps. Display 520 can be a color display, a cathode-ray tube (CRT), a liquid crystal display (LCD), a plasma display, an organic light-emitting diode (OLED) display, etc.

In some embodiments, display 520 can be detached from image capture device 510. In such embodiments, flicker identification device 500 can include a plurality of displays 520. For example, display 520 can be a television screen or a projection screen. In another example, display 520 can be a hand-held, portable device. In some embodiments, display 520 can be a smartphone. In the embodiment where display 520 is a smartphone, processed images can be received from an external source (e.g., a video camera). In some embodiments, images and/or video can be sent to the display 520 via a wired connection or a wireless connection. In such embodiments, flicker identification device 500 can include one or more transceivers configured to transmit and/or receive data, including user inputs, settings, images, temporal difference maps, etc. Any methods or devices known in the art to transmit images and/or video can be used.

In embodiments in which image capture device 510 is detached from display 520, operations described herein can be performed via computing devices of either and/or both image capture device 510 and display 520. Accordingly, in some embodiments, flicker identification device 500 can include one or more processors 540, memory 550, power sources 560, etc. For example, image capture device 510 can capture images, process the images, produce temporal difference maps, and transmit the temporal difference maps for display on display 520. In another example, image capture device 510 can capture images and transmit the images to display 520. Display 520 can process the images, produce temporal difference maps, and display the temporal difference maps. In alternative embodiments, some of the processing can be performed by the image capture device 510 and some of the processing can be performed by the display 520.

In other embodiments, display 520 can be attached and/or integral to a device that includes image capture device 510. For example, many video cameras include a display that displays a representation of what the video camera is recording (or viewing). Such displays can be used as display 520. In embodiments in which display 520 is a smartphone, display 520 can receive video via a camera of the smartphone. Video can be transmitted using wired or wireless communications. In yet other embodiments, a video camera can include multiple displays, one of which can be display 520. In some embodiments, a display 520 of image capture device 510 can be dedicated to displaying or can primarily display temporal difference maps.

In an illustrative embodiment, display 520 can be configured to display temporal difference maps only part time. For example, display 520 can be configured to primarily display what image capture device 510 is aimed at, viewing, recording, etc. Temporal difference maps can be displayed upon receipt of a user input indicating that temporal difference maps should be displayed. In some embodiments, display 520 can automatically change between a primary display (such as what image capture device 510 is viewing) and a display of temporal difference maps. During display of the temporal difference maps, display 520 can be configured to display one or more temporal difference maps. Further, the frequency of displaying the temporal difference maps can be, for example, once every 0.1 seconds, 0.5 seconds, 1 second, 5 seconds, 20 seconds, 1 minute, 2 minutes, etc. In some embodiments, the duration of the display of the temporal difference maps, number of temporal difference maps to display, and/or frequency of displaying temporal difference maps can be user defined.

In some embodiments, display 520 can be configured to display temporal difference maps in a portion of the screen. For example, temporal difference maps can be displayed in a picture-in-picture sub-box of the display 520. In such an example, the primary display area of display 520 can be used to display a representation of what the image capture device 510 is viewing. In another example, the primary display can be of temporal difference maps and a picture-in-picture sub-box can display a representation of what the image capture device 510 is viewing.

In some embodiments, display 520 can be a waveform monitor. A waveform monitor can be used to display the brightness (e.g., luminance) of an image. In some embodiments, instead of displaying the temporal difference map directly, as discussed above, the temporal difference map can be input into a waveform monitor. The waveform monitor can then process the temporal difference map to display the brightness of the temporal difference map. The display of the waveform monitor can be used to detect that flicker or banding exists. In some embodiments, the waveform monitor may indicate that something is undesirable (e.g., flicker or banding), but may not indicate what it is that is undesirable. Similarly, in some embodiments, display 520 can be a vectorscope.

Flicker identification device 500 can also include user interface 530. User interface 530 can be any user interface known in the art. User interface 530 can be an interface for receiving user input and/or machine instructions for entry into flicker identification device 500 as known to those skilled in the art. User interface 530 may use various input technologies including, but not limited to, a keyboard, a stylus and/or touch screen, a mouse, a track ball, a keypad, voice recognition, motion recognition, disk drives, remote controllers, input ports, one or more buttons, dials, joysticks, etc. to allow an external source, such as a user, to enter information into flicker identification device 500. User interface 530 can be used to navigate menus, adjust options, adjust settings, adjust display, etc. For example, user interface 530 can be used to receive modifications to a display contrast, saturation, brightness, amount of grey level used in the temporal difference map (e.g., the baseline or constant image), or other display settings. User interface 530 can be used to receive settings such as how many images (or a length of time) N-image buffer 420 should buffer, an amount of increase of contrast and/or saturation that contrast and saturation booster 450 should apply, etc.

In some embodiments, user interface 530 can be used to adjust display settings of display 520. Some settings that can be adjusted can include color correction/adjustment, black and white settings, zoom, orientation, size, resolution, picture-in-picture, brightness, brightness variation exaggeration, etc. User interface 530 can further be configured to receive inputs indicating that adjustments should be made to image capture device 510. For example, user interface 530 can be configured to receive inputs to adjust shutter speed, image capture rate (e.g., frame rate or frames per second), resolution, white balance, gain, sensitivity (e.g., ISO settings), scene profile, focus, aperture settings, etc.

In embodiments in which monochromatic images are used, user interface 530 can be used to input a user selection of a type of monochromatic images to process. For example, image capture device 410 can capture color images and system 400 can convert the captured color images into monochromatic images. User interface 530 can be used to adjust settings of the conversion of color images into monochromatic images. For example, user interface 530 can be used to input a selection of using red-and-white monochromatic images, green-and-white monochromatic images, blue-and-white monochromatic images, etc.

In some embodiments, user interface 530 can allow a user to cycle through images of a video individually or otherwise control which images are being processed. As discussed above, a previously recorded video can be used in place of an image capture device 510. In such embodiments, the stream of images received from the previously recorded video (which can be stored in memory 550) can be controlled, for example, by a user. User interface 530 can receive an input indicating that a next (or previous) image should be processed. In such a manner, a user can step through a video (or a portion of a video) frame-by-frame. Such embodiments can help a user to more closely analyze the temporal difference maps. In such embodiments, the user interface 530 can also change the number of images buffered (e.g., in N-image buffer 420) while maintaining the same reference image. That is, a reference image (shown as being received from image capture device 410 by compositor 440 in FIG. 4) can be compared against an image that was captured N images before the reference image, where N can be user adjustable. In yet other embodiments, user interface 530 can receive an input indicating that the reference image should be incremented or decremented in the series of images (e.g., video).

Flicker identification device 500 can include processor 540. Processor 540 can be configured to carry out and/or cause to be carried out one or more operations described herein. Processor 540 can execute instructions as known to those skilled in the art. The instructions may be carried out by a special purpose computer, logic circuits (e.g., a field-programmable gate array (FPGA)), or hardware circuits. Thus, processor 540 may be implemented in hardware, firmware, software, or any combination of these methods. The term “execution” is the process of running an application or the carrying out of the operation called for by an instruction. The instructions may be written using one or more programming language, scripting language, assembly language, etc. Processor 540 executes an instruction, meaning that it performs the operations called for by that instruction. Processor 540 operably couples with image capture device 510, display 520, user interface 530, memory 550, etc. to receive, to send, and to process information and to control the operations of the flicker identification device 500. Processor 540 may retrieve a set of instructions from a permanent memory device such as a read-only memory (ROM) device and copy the instructions in an executable form to a temporary memory device that is generally some form of random access memory (RAM). The flicker identification device 500 may include a plurality of processors that use the same or a different processing technology. In an illustrative embodiment, the instructions may be stored in memory 550.

Flicker identification device 500 can include memory 550. Memory 550 can be an electronic holding place or storage for information so that the information can be accessed by processor 540 as known to those skilled in the art. Memory 550 can include, but is not limited to, any type of random access memory (RAM), any type of read-only memory (ROM), any type of flash memory, etc. such as magnetic storage devices (e.g., hard disk, floppy disk, magnetic strips, etc.), optical disks (e.g., compact disk (CD), digital versatile disk (DVD), etc.), smart cards, flash memory devices, etc. Flicker identification device 500 may have one or more computer-readable media that use the same or a different memory media technology. Flicker identification device 500 may have one or more drives that support the loading of a memory medium such as a CD, a DVD, a flash memory card, etc.

Flicker identification device 500 can include power source 560. Power source 560 can be configured to provide electrical power to one or more elements of flicker identification device 500, such as processor 540, image capture device 510, display 520, etc. In some embodiments, power source 560 can be alternating current power, such as line power (e.g., 120 Volts alternating current (VAC) at 60 Hz, 220 VAC at 50 Hz, etc.). Power source 560 can be configured to convert electrical energy from a source into a useable form for the various elements of flicker identification device 500 (e.g., 12 Volts direct current (VDC), 8.5 VDC, etc.). In some embodiments, power source 560 can include batteries. In some embodiments, power source 560 can include one or more alternating current power sources (e.g., line power) and/or one or more direct current power sources (e.g., a battery). In such embodiments, power source 560 can be configured to charge a battery with an alternating current power source.

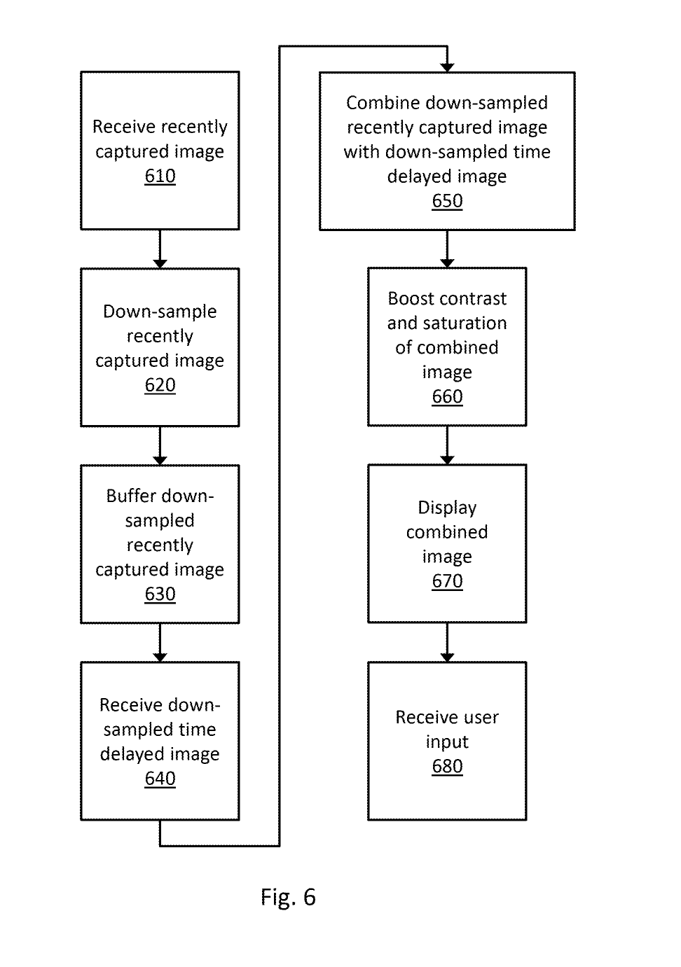

FIG. 6 is a flow diagram illustrating a method of processing images in accordance with an illustrative embodiment. In alternative embodiments, fewer, additional, and/or different operations may be performed. Also, the use of a flow diagram is not meant to be limiting with respect to the order of operations performed. In an operation 610, a recently captured image can be received. The recently captured image can be received, for example, from a video camera. In some embodiments, only a portion of the recently captured image is received. In alternative embodiments, the entire recently captured image can be received, but only a portion of the recently captured image is used. In such embodiments, any suitable portion of the recently captured images can be used. For example, the portion of the image can be a vertical strip of the recently captured image. In such embodiments, however, the resulting temporal difference map may not include localized flicker or banding that is in the image, but not within the portion used.

In an operation 620, the recently captured image can be down-sampled. Down-sampling images can comprise reducing a resolution of an image. Any down-sampling method known in the art can be used. In some down-sampling methods, some pixels can be ignored or deleted from an image. In another down-sampling method, adjacent pixels can be averaged together and/or combined. In some embodiments, operation 620 is not performed. The recently captured image can be down-sampled to ½, ¼, 1/16, 1/32, etc. of its original size. In some embodiments, the recently captured image can be down-sampled to ratios that are greater than ½ or less than 1/32. In some embodiments, the recently captured image can be down-sampled to ratios that do not correspond to an integer exponent of ½ (e.g., 3/11 can be used).

Down-sampling of images can have added benefits to the methods and devices described herein. Down-sampling of images reduces storage space of the images. Thus, memory can be saved (or reduced) by using down-sampled images instead of full-sized images. Accordingly, the storage capacity of memory (e.g., memory 550) can be reduced. Alternatively (or in addition to), the maximum number of buffered images (e.g., in N-image buffer 420) can be increased. Down-sampling of images in which pixel averaging or pixel combining is used also reduces the effect of random noise. Reduction in random noise can be increased depending upon the method of down-sampling used. For example, averaging adjacent pixels together can reduce random noise compared to discarding some of the pixels in an image. Down-sampling images can reduce computational time. Combining images, for example, as discussed above with regard to compositor 440, can be simplified if the images to be combined have smaller storage space.

Although down-sampling of images decreases the size of the images and, therefore, decreases the resolution and the amount of data contained in the images, down-sampling can increase the appearance of large-area effects such as flicker and banding in the temporal difference map relative to small-area effects such as pixel noise. Additionally, depending upon the size that the temporal difference map is to be displayed at, down-sampling may have to be performed at some point in the process to display the temporal difference map on the display. Accordingly, in some embodiments, down-sampling can occur after a temporal difference map is produced.

In an operation 630, the down-sampled image that was recently captured can be buffered. For example, the down-sampled image can be buffered in the N-image buffer 420 and/or can be stored in memory 550. In an operation 640, a previously down-sampled image can be received from the buffer. Accordingly, the previously down-sampled image is time delayed.

In an operation 650, the down-sampled, recently captured image can be combined with the down-sampled, time-delayed image. As discussed above, any method known in the art can be used to combine the images. For example, the time-delayed image can be subtracted from the recently captured image using a numerical representation that allows excursions below zero. A grey offset can be added to the image resulting from the subtraction. The grey offset can be added to allow positive and negative deviations to be seen. That is, in some embodiments, the excursions below zero in an image with a grey offset can be seen as darker than the grey offset while excursions above zero can be seen as brighter than the grey offset.

In an operation 660, the contrast and saturation of the temporal difference map (the image resulting from the combination of the down-sampled, recently captured image and the down-sampled, time delayed image) can be increased or boosted. In some embodiments, contrast of the temporal difference map can be boosted by five to fifty times. In alternative embodiments, contrast can be boosted more than thirty times or less than twenty times. In some embodiments, saturation of the temporal difference map can be increased. For example, saturation of the temporal difference map can be increased by five to fifty times. In some embodiments, adjustments of contrast and/or saturation can be user controlled. In some embodiments, operation 660 is not performed.

In an operation 670, the temporal difference map can be displayed. The temporal difference map can be displayed using any method known in the art. For example, the temporal difference map can be displayed on display 520.

In an operation 680, a user input can be received. The user input can be received, for example, via user interface 530. The user input can indicate that one or more settings are to be adjusted. As discussed above, some settings that may be adjusted can be the number of frames in the buffer (e.g., N-frame buffer 420), the base-level brightness/grey, contrast, saturation, etc.

Some camera settings to be adjusted can include a shutter speed of a camera, frame capture rate of the camera, a frame rate of a frame (e.g., adding time between the capture of two images, but not adding the time between subsequent images), use of a global shutter or a rolling shutter, etc. As discussed above, flicker and banding occur because the camera captures images at a rate that is not synchronized to the brightness cycle of the lamps that light the scene captured by the camera. That is, the consecutive images captured by the camera are not captured at the same point in the brightness cycle of the lamps. However, the amount of flicker and/or banding depends upon the magnitude of the discrepancy between lamp brightness cycles captured. Banding can also be caused, for example in images captured using a rolling shutter, when the frame integration time (e.g., the inverse of shutter speed) is not an integral multiple of the lamp's brightness cycle time. In some instances, the lamp's brightness cycle time can be half of the lamp's electrical cycle time. In some instances, the lamp's brightness cycle time can be the full electrical cycle time of the lamp. For example, the brightness of the light emitted from the lamp can be different for the portion of the electrical cycle that is positive than for the portion of the electrical cycle that is negative.

Accordingly, adjusting the portion of the brightness cycle captured by each image can affect the amount of flicker and/or banding. As discussed above with respect to FIGS. 1A, 2A, and 3A, adjusting the frame rate of the camera can affect flicker and banding. For example, as shown in FIG. 1A, a frame rate that is equal to the electrical cycle rate (e.g., two brightness cycles) of the lamp results in no flicker or banding. Thus, in some instances, a camera operator can adjust the frame rate to more closely match the electrical cycle and/or brightness cycle of the lamp (or an integer number of electrical cycles and/or brightness cycles). In many instances, however, the camera operator may not be permitted to adjust the frame rate. For example, the frame rate may be determined by other factors such as industry standards, a specific frame rate for a particular display medium or transmission method, environmental conditions, production requirements, etc. Further, the frame rate may be determined by what is supposed to be captured. For example, a particular frame rate may be required for slow-motion filming, time-lapse filming, etc.

Another setting that may be adjusted is the shutter speed of the camera. The shutter speed of the camera can be how long it takes the camera to capture each image. In the examples illustrated in FIGS. 1A, 2A, and 3A, the shutter speed of the camera is the maximum permitted by the frame rate. For example, if the frame rate of FIG. 1A is 25 frames per second (fps), then the camera captures one image every 0.04 seconds. Accordingly, the shutter speed of the camera in such an example is 0.04 seconds because, as shown in FIG. 1A, there is no time delay between the camera finishing the capture of an image and beginning to capture the next image.

In some embodiments, the camera operator can adjust the shutter speed of the camera without adjusting the frame rate. Using the example above, a camera can have a frame rate of 25 fps, but the shutter speed can be less than 0.04 seconds per frame. The shutter speed can be 0.0399 seconds per frame, 0.035 seconds per frame, 0.03 seconds per frame, 0.02 seconds per frame, 0.001 seconds per frame, etc. In some embodiments, the lower limit of the shutter speed setting can be determined by the physical or electronic limitations of the camera. An adjustment in the shutter speed of the camera can affect flicker and/or banding because such an adjustment necessarily affects the portion of the lamp's brightness cycle captured in each image, as illustrated in FIGS. 3A-3F. However, in some instances, a camera operator may not be permitted to adjust the shutter speed or adjusting the shutter speed can be undesirable. For example, in some instances, decreasing the shutter speed may decrease flicker and/or banding but may also decrease the quality of the images captured. In other instances, increasing the shutter speed may decrease the quality of the images captured. Environmental and/or lighting conditions can also determine the shutter speed of a camera.

In some embodiments, the user input may indicate that a single time delay is added between two images. For example, if a camera captures images at 25 fps, then one image is captured every 0.04 seconds. However, a user input may indicate that, for example, a 0.01 second delay is added once, between the capture of two images but not between the capture of subsequent images. The time delay added between the two images can be, for example, 0.001 seconds, 0.002 seconds, 0.02 seconds, 0.021 seconds, 0.03 seconds, 1 second, etc.

A time delay may be added to adjust the portion of the phase captured in each image. For example, FIG. 1A shows a frame rate that coincides with the brightness cycle of the lamp. When the images in such an example are beginning to be captured (at the top of the image), the brightness cycle of the lamp is transitioning from dim to bright. Accordingly, the brightest portions of the image will be one quarter of the way down from the top of the image and one quarter of the way up from the bottom of the image. Similarly, the dimmest portions of the image will be at the top, middle, and bottom of the image. In some instances, it may be desirable to adjust which portions of the image are brightest and dullest. Accordingly, a single time delay added between two captured images can shift the brightest and dullest portions of an image by adjusting where in the lamp's brightness phase each image capture begins. Similarly, the user input can indicate that the time between two images is less than the typical frame rate.

In some embodiments, operation 680 may not be performed. For example, environmental and/or lighting conditions can be adjusted to affect the flicker and/or banding. In some instances, the position of lamps can be adjusted, thereby affecting the light sensed by the camera. In other instances, the number of lamps can be modified. For example, one or more lamps can be added to illuminate the scene. The light cycles emitted by the multiple lamps can be out of phase with each other, as sensed by the camera. In some instances, the multiple lamps that are out of phase with one another can minimize and/or cancel out the flicker and/or banding of the video. In other embodiments, the brightness cycle of the lamps can be adjusted. For example, duty-cycle modulation can be used to adjust the power of the lamps and, accordingly, the brightness of the lamps and the brightness cycles of the lamps.

In some embodiments, operation 680 may be performed by a device different than a device that performs another operation shown in FIG. 6. For example, flicker identification device 500 can be a stand-alone device that is independent from a video camera and can receive images from the video camera. The video camera can receive the user input to modify one or more of the settings.

In an illustrative embodiment, any of the operations described herein can be implemented at least in part as computer-readable instructions stored on a computer-readable memory. Upon execution of the computer-readable instructions by a processor, the computer-readable instructions can cause a node to perform the operations.

The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A device comprising:
a processor operatively coupled to the user interface and configured to:
receive a plurality of digital images comprising a first digital image and a second digital image;
store a portion of the plurality of digital images in a buffer memory, wherein the buffer memory is configured to buffer a number of digital images received between the first digital image and the second digital image; and
combine the first digital image and the second digital image to create a temporal difference map; and
a display configured to display the temporal difference map.

2. The device of claim 1, further comprising a user interface configured to receive a user input, wherein the processor is further configured to receive, from the user interface, the user input, which indicates the number of digital images received between the first digital image and the second digital image.

3. The device of claim 1, wherein the processor is further configured to determine the number of digital images received between the first digital image and the second digital image based on a previous number of digital images received between the first digital image and the second digital image.

4. The device of claim 3, further comprising a delay data interface configured to receive an input indicating that the display is to display a plurality of sequential temporal difference maps, wherein each of the plurality of sequential difference maps has a different number of digital images received between the first digital image and the second digital image.

5. The device of claim 1, wherein the portion of the plurality of digital images is the second digital image, and wherein the number of digital images received between the first digital image and the second digital image is zero.

6. The device of claim 1, further comprising a digital camera configured to capture the plurality of digital images.

7. The device of claim 6, wherein the display is configured to display the temporal difference map and the first digital image concurrently.

8. The device of claim 1, further comprising a storage memory configured to store the plurality of digital images, and wherein the processor is configured to receive the plurality of digital images from the storage memory.

9. The device of claim 1, wherein the processor is further configured to create a monochromatic inverted first digital image and a monochromatic second digital image that are used to combine the first digital image and the second digital image.

10. The device of claim 1, wherein the processor is further configured to create a color inverted first digital image that is used to combine the first digital image and the second digital image.

11. The device of claim 10, wherein the color inverted first digital image and the second digital image each comprise a plurality of color code values, wherein each color code value corresponds to a pixel location, and wherein the processor is configured to combine the first digital image and the second digital image by adding color code values of the color inverted first digital image with corresponding color code values of the second digital image.

12. The device of claim 1, wherein a contrast level and a color saturation level of the temporal difference map is greater than a color contrast level and a color saturation level of the first digital image and the second digital image.

13. The device of claim 1, wherein the processor is configured to receive the first digital image from the buffer memory.

14. The device of claim 1, wherein the processor is further configured to down-sample the plurality of digital images.

15. A method comprising:
receiving, by a processor, a plurality of digital images comprising a first digital image and a second digital image;
storing, by the processor, the plurality of digital images in a buffer memory, wherein the buffer memory stores a number of digital images received between the first digital image and the second digital image;
combining, by the processor, the first digital image and the second digital image to create a temporal difference map; and
displaying, on a display, the temporal difference map.

16. The method of claim 15, wherein said receiving the plurality of digital images is from a digital camera configured to capture the plurality of digital images.

17. The method of claim 15, wherein said combining the first digital image and the second digital image comprises creating a color inverted first digital image.

18. The method of claim 17, wherein the color inverted first digital image and the second digital image each comprise a plurality of color code values, wherein each color code value corresponds to a pixel location, and wherein said combining the first digital image and the second digital image comprises adding color code values of the color inverted first digital image with corresponding color code values of the second digital image.

19. A non-transitory computer-readable medium having computer-readable instructions stored thereon that, upon execution by a processor, cause a device to perform operations, wherein the instructions comprise:
instructions to receive a plurality of digital images comprising a first digital image and a second digital image;
instructions to store the plurality of digital images in a buffer memory, wherein the buffer memory stores a number of digital images received between the first digital image and the second digital image;
instructions to combine the first digital image and the second digital image to create a temporal difference map; and
instructions to display the temporal difference map on a display.

20. The non-transitory computer-readable medium of claim 19, wherein the instructions to receive the plurality of digital images comprise instructions to receive the plurality of digital images from a digital camera configured to capture the plurality of digital images.
